(19) United States
(12) Patent Application Publication
(10) Pub. No.: US 2008/0174032 A1
(43) Pub. Date: Jul. 24, 2008

(54) Hazardous substance removing apparatus and cylindrical unit for promoting contact with hazardous substance

(75) Inventors: Eiji Murata, Hachioji (JP); Shinji Kaneko, Hachioji (JP)

Correspondence Address: SCHWEGMAN, LUNDBERG & WOESSNER, P.A., P.O. BOX 2938, MINNEAPOLIS, MN, 55402, US

(73) Assignees: Eiji Murata; ASAHI KAKO CO., Ltd.

(21) Appl. No.: 11/786,998

(22) Filed: Apr. 13, 2007

(30) Foreign Application Priority Data
Apr. 20, 2006 (JP) 2006-117027

(51) Int. Cl. B01D 47/02

(52) U.S. Cl. 261/76

(57) ABSTRACT

A hazardous substance removing apparatus according to the present invention comprises a bath in which a liquid collecting agent collecting a hazardous substance in gaseous form is stored, a suction tower of a cylindrical or almost cylindrical shape, which suctions the hazardous substance in gaseous form from a top opening of the tower itself, blends the hazardous substance with the collecting agent injected from a plurality of nozzles arranged inside the tower itself, and sends the blend to the bath via a bottom opening of the tower itself, an emission tower which is open into the bath via a bottom opening of the tower itself, and can make emission via a top opening of the tower itself, and a pump which pumps up the collecting agent within the bath. In the suction tower, the plurality of nozzles are arranged to make the collecting agent injected from the nozzles form a flow along an inner wall.

### BACKGROUND OF THE INVENTION

1. Field of the Invention

The present invention relates to a hazardous substance removing apparatus for removing a hazardous substance in gaseous form emitted from a plant or the like.

2. Description of the Related Art

In plants, a variety of industrial products are manufactured. In their processes, oily smoke occurs in many cases.

For example, when a metal heated to 800° C. is thrown into oil, and when the metal is heated with a burner at the time of tempering, oily smoke is generated by the oil (mineral oil) adhering to the metal. Additionally, oily smoke occurs, for example, when canvas is impregnated with a plasticizer of vinyl chloride (DOP) and liquefied vinyl chloride, and dried at the time of manufacturing a tent. Furthermore, oily smoke occurs also when vinyl chloride, which is used as a material for shoes, a floor material, a building material, etc., is dried. Still further, oily smoke occurs when oil (several types of mineral oil) are put on a string in order to apply a color at the time of dying, and the oil evaporates at the time of being dried. Still further, oily smoke occurs from the oil (mineral oil) of a cylinder of a vacuum pump or a compressor at the time of operations.

Besides, oily smoke also occurs in a case where resin is mixed when rubber is kneaded with a roller. Additionally, in an incinerator, all of things are burnt, and many of them contain carbon. Also carbon (CO) is one type of oil in a broad sense. Accordingly, it can be said that oily smoke occurs also from an incinerator when a waste is burnt. Furthermore, oily smoke occurs also when coal is burnt.

Most of hazardous substances including oily smoke are gases. Desirably, their emission amounts are suppressed if an influence on an environment or a human body is considered.

A burning method disclosed in Non-Patent Document 1, etc. is known as a first conventional technique for removing such a hazardous substance in gaseous form. With this method, oily smoke is again burnt by using butane, and removed.

However, this method requires the cost of equipment such as a boiler, etc., the cost of butane as a fuel, and the like, and cannot be realized at low cost. Furthermore, this method has a disadvantage such that carbon dioxide (CO2) is emitted as a result of the process for removing oily smoke.

In the meantime, an electric dust collector exists as a second conventional technique. With this technique, oil contained in oily smoke is flown out by making the oily smoke adhere to an electrode. However, this technique frequently causes a fire accident, and has a problem from a safety viewpoint. [Non-Patent Document 1] “Deodorizing Technique in Implementation Examples”, HIYAMA Kazunari, Kogyo Chosakai Publishing Co., Ltd., page 55, October 1999, First Edition issued

### SUMMARY OF THE INVENTION

It is an object of the present invention to provide a hazardous substance removing apparatus, which can efficiently remove a hazardous substance in gaseous form with a simple configuration in consideration of a peripheral environment, and a cylindrical unit for promoting contact with a hazardous substance.

A hazardous substance removing apparatus in a first aspect of the present invention comprises: a bath in which a liquid collecting agent collecting a hazardous substance in gaseous form is stored; a suction tower of a cylindrical or almost cylindrical shape, which suctions the hazardous substance in gaseous form from a top opening of the tower itself, blends the hazardous substance with the collecting agent injected from a plurality of nozzles arranged inside the tower itself, and sends the blend to the bath via a bottom opening of the tower itself; an emission tower which is open into the bath via a bottom opening of the tower itself, and can make emission via a top opening of the tower itself; and a pump which pumps up the collecting agent within the bath, wherein the plurality of nozzles are arranged inside the suction tower to make the collecting agent injected from the nozzles form a flow along an inner wall.

Here, according to experiment results, which are found by the present applicant, that the blend of a collecting agent and a certain type of a hazardous substance in gaseous form, such as oily smoke, etc., is promoted by arranging the plurality of nozzles to make the collecting agent injected from the plurality of nozzles forma flow along the inner wall of the suction tower, a hazardous substance in gaseous form can be efficiently removed with a simple configuration. Additionally, since burning is not made during the course of a process where the hazardous substance in gaseous form, such as oily smoke, etc., is blended with the collecting agent and liquefied, carbon dioxide, etc. are not emitted (or only a minute quantity which does not matter is emitted). Therefore, the hazardous substance in gaseous form can be removed in consideration of a peripheral environment.

Furthermore, because the suction tower has a cylindrical or almost cylindrical shape, the plurality of nozzles can be arranged inside the suction tower by removing a blind spot of the collecting agent injected from the nozzles to a maximum extent, and the effect of removing the hazardous substance in gaseous form can be further increased, in comparison with a case where the suction tower has other shapes except for the cylindrical or almost cylindrical shape.

In the first aspect, the plurality of nozzles are arranged to make the collecting agent injected from the nozzles form a flow along the inner wall, and the collecting agent may be injected from the nozzles to remove or almost remove a blind spot.

In this way, the present applicant found it from an experiment that a hazardous substance in gaseous form can be efficiently removed.

Additionally, in the first aspect, the plurality of nozzles may be attached to the sides of a plurality of pipes arranged in the longitudinal direction of the suction tower, and the pipes may be arranged inside the suction tower.

In this way, a load on the operations for drilling holes on the suction tower is reduced, and the hazardous substance removing apparatus can be manufactured more easily, for example, in comparison with a case where the plurality of nozzles are attached to the tips of pipes branching from the plurality of pipes arranged in the longitudinal direction of the suction tower, and the branching pipes are inserted into the suction tower via the holes arranged on the side of the suction tower.

A cylindrical unit in a second aspect of the present invention is a cylindrical unit of a cylindrical or almost cylindrical shape, which is intended to promote contact with a hazardous substance and comprises openings at both ends, and the inside of which is hollow, wherein: a hazardous substance in gaseous form is suctioned from the opening at one end, blended with a collecting agent injected from a plurality of nozzles arranged inside the unit itself, and emitted via the opening at the other end; and the plurality of nozzles are arranged inside the cylindrical unit to make the collecting agent injected from the nozzles form a flow along an inner wall.

According to the present invention, a hazardous substance in gaseous form can be efficiently removed with a simple configuration. Additionally, since the hazardous substance is removed without making burning, carbon dioxide, etc. are not emitted (or only a minute quantity which does not matter is emitted) . Accordingly, the hazardous substance in gaseous form can be removed in consideration of a peripheral environment.

### BRIEF DESCRIPTION OF THE DRAWINGS

FIG. 1A is a front view of a hazardous substance removing apparatus according to a first preferred embodiment of the present invention;

FIG. 1B is a rear view of the hazardous substance removing apparatus according to the first preferred embodiment of the present invention;

FIG. 2 is a schematic explaining the state of pipes arranged in the longitudinal direction of a suction tower in the first preferred embodiment;

FIG. 3 is a cross-sectional view in any of arrangement positions of nozzles shown in FIG. 2 when viewed from above;

FIG. 4A is a cross-sectional view showing an arrangement example (No. 1) of nozzles when four pipes are arranged in a suction tower;

FIG. 4B is a cross-sectional view showing an arrangement example (No. 2) of nozzles when four pipes are arranged in a suction tower;

FIG. 5 is a cross-sectional view showing an arrangement example of nozzles when six pipes are arranged in a suction tower;

FIG. 6 is a schematic showing the suction tower when viewed in the direction of an arrow X shown in FIG. 1A;

FIG. 7A is a schematic showing the configuration of a blower;

FIG. 7B is a schematic explaining the usage of the blower;

FIG. 8A is a front view of a hazardous substance removing apparatus according to a second preferred embodiment of the present invention;

FIG. 8B is a rear view of the hazardous substance removing apparatus according to the second preferred embodiment of the present invention;

FIG. 9 is a schematic explaining the arrangement of nozzles in a suction tower in the second preferred embodiment;

FIG. 10 is a schematic showing the suction tower in the second preferred embodiment when viewed from above;

FIG. 11 is a schematic showing the suction tower when viewed in the direction of an arrow X shown in FIG. 8A; and

FIG. 12 is a schematic explaining the usage of the hazardous substance removing apparatus when a volatile organic solvent is removed.

### DESCRIPTION OF THE PREFERRED EMBODIMENTS

Preferred embodiments according to the present invention are hereinafter described in detail with reference to the drawings.

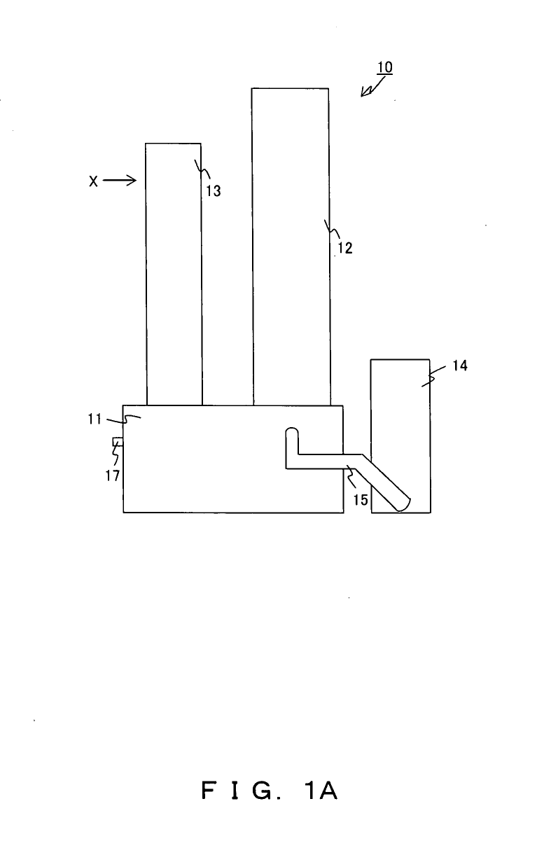

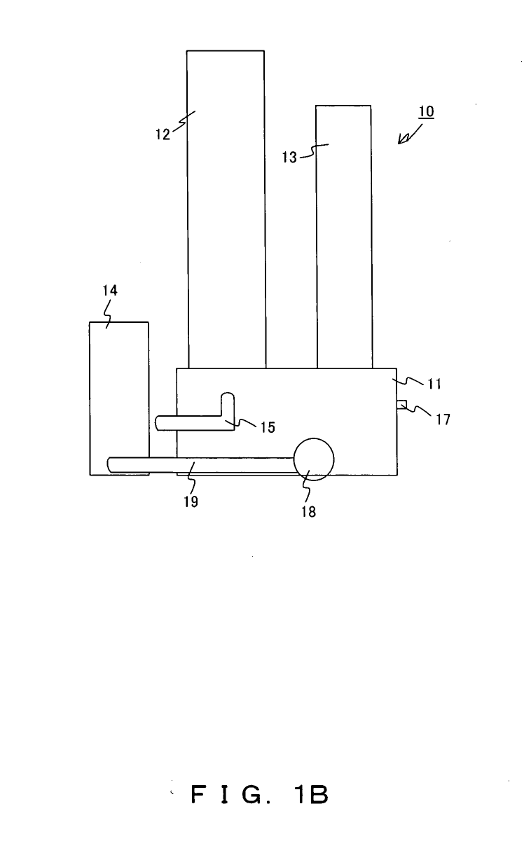

FIGS. 1A and 1B are respectively front and rear views of a hazardous substance removing apparatus according to the first preferred embodiment of the present invention.

In FIG. 1A, the hazardous substance removing apparatus 10 comprises: a bath 11 in which a liquid collecting agent collecting a hazardous substance in gaseous form is stored; a suction tower 12 of a cylindrical or almost cylindrical shape, which suctions the hazardous substance in gaseous form from a top opening of the tower itself, blends the hazardous substance with the collecting agent injected from a plurality of nozzles arranged inside the tower itself, and sends the blend to the bath 11 via a bottom opening of the tower itself; an emission tower 13 which is open into the bath 11 via a bottom opening of the tower itself, and makes emission via a top opening of the tower itself; and a pump 14 which pumps up the collecting agent within the bath 11. It can be said that the suction tower 12 is a tower unit (cylindrical unit) for promoting contact between the hazardous substance and the collecting agent.

FIG. 1A is the front view of the apparatus, whereas FIG. 1B is its rear view. As shown in FIG. 1B, the collecting agent within the bath 11 is sent to the pump 14 via a hole 18 and a pipe 19, which exist almost at the bottom of the bath 11. Then, the pump 14 pumps up the collecting agent to the position of each of the nozzles within the suction tower 12.

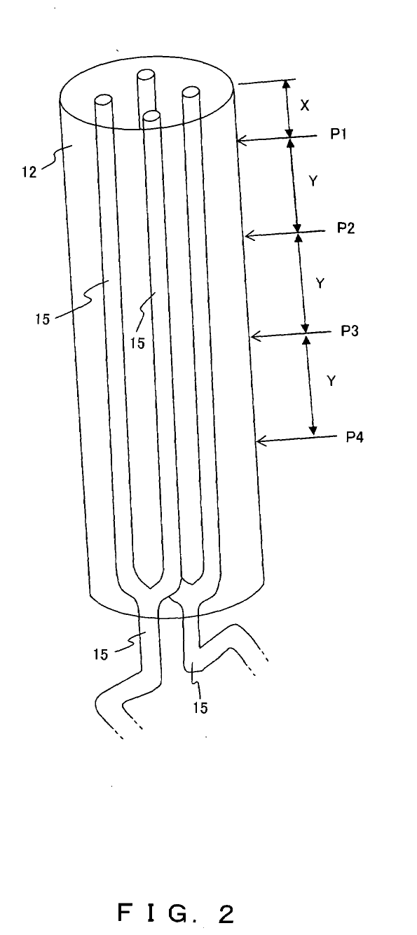

FIG. 2 is a schematic explaining the state of pipes arranged in the longitudinal direction of the suction tower. Each pipe 15 shown in FIG. 1 branches to four pipes within the suction tower 12 as shown in FIG. 2. These four pipes are arranged in parallel to the longitudinal direction of the suction tower 12 as shown in this figure. The nozzles are respectively attached to a position P1 going down from the top end of the suction tower 12 by a distance X, a position P2 further going down from the position P1 by a distance Y, a position P3 going down from the position P2 by the distance Y, and the like. The liquid (collecting agent) is injected from each of the nozzles at a predetermined angle. However, the position where the nozzle is first arranged when viewed from the top end is apart from the top end by the distance X in order to prevent the collecting agent from splashing out of the top end of the suction tower 12.

In this way, the collecting agent pumped up by the pump 14 is injected within the suction tower 12 via the nozzles respectively attached to the sides of the pipes 15 within the suction tower 12. As a result, the hazardous substance in gaseous form and the collecting agent contact and blend with each other within the suction tower 12. Note that each of the nozzles has a thin hole at its tip, from which the collecting agent is injected.

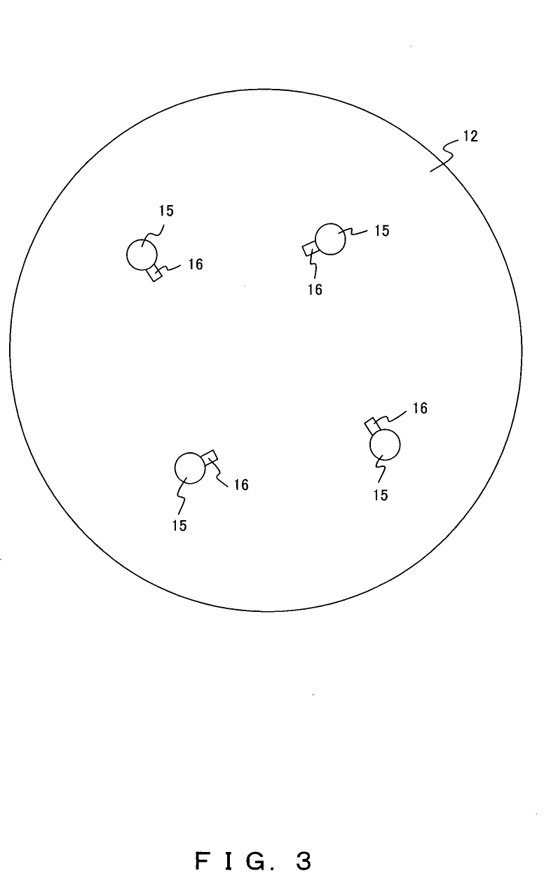

FIG. 3 is a cross-sectional view in any of the arrangement positions of the nozzles shown in FIG. 2 when viewed from above. As shown in this figure, each of the nozzles 16 protrudes from each of the pipes 15 to make the collecting agent injected from the nozzles 16 form a clockwise or counterclockwise flow (the counterclockwise flow in FIG. 3) along the inner wall. Whether the flow of the injected collecting agent is made either clockwise or counterclockwise is determined for each of the arrangement positions in the suction tower 12. For example, the clockwise or counterclockwise flow may be made to occur in all of the arrangement positions. Or, the orientation of the flow may be alternately changed in the positions.

The present applicant conducted an experiment by changing the arrangement of the nozzles. According to the results of the experiment, one of the best cases where a hazardous substance in gaseous form is removed to a maximum extent is proved to be a case where the respective nozzles are arranged to make the collecting agent injected from the nozzles form a clockwise or counterclockwise flow along the inner wall of the suction tower for a certain type (in gaseous form) of oily smoke, etc.

This is probably because the flow is rotated along the inner wall, whereby a time during which the hazardous substance in gaseous form contacts with the collecting agent becomes longer.

Additionally, the present applicant found it through the experiment that the effect of removing the hazardous substance in gaseous form is further increased by making the collecting agent injected from each of the nozzles 16 remove a blind spot to a maximum extent.

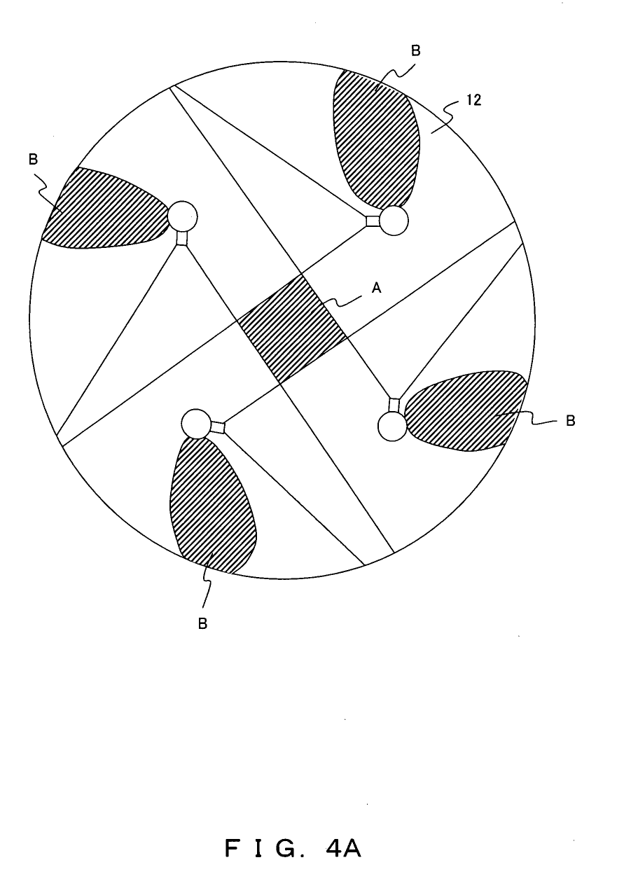

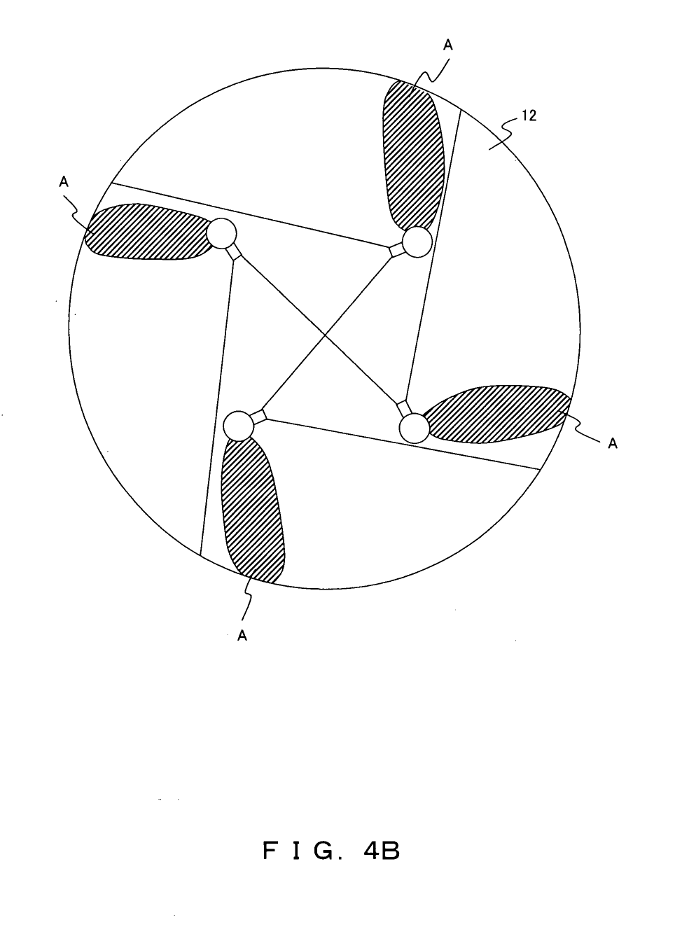

Namely, the angle of the collecting agent injected from each of the nozzles 16 is determined according to a pressure applied to each of the nozzles 16. If the nozzles 16 are respectively attached to the pipes 15 in orientations shown in FIG. 4A, a shaded portion A shown in FIG. 4A becomes a blind spot to which the collecting agent is not injected, and shaded portions B become portions where the degree of blend of the collecting agent and the hazardous substance in gaseous form is low.

In the meantime, if the respective nozzles 16 are attached to the pipes 15 in orientations shown in FIG. 4B, a blind spot to which the collecting agent is not injected is removed. Therefore, the blend of the collecting agent and the hazardous substance in gaseous form is further promoted. However, in FIG. 4B, portions where the degree of blend of the collecting agent and the hazardous substance in gaseous form is low (shaded portions A of FIG. 4B) still remain.

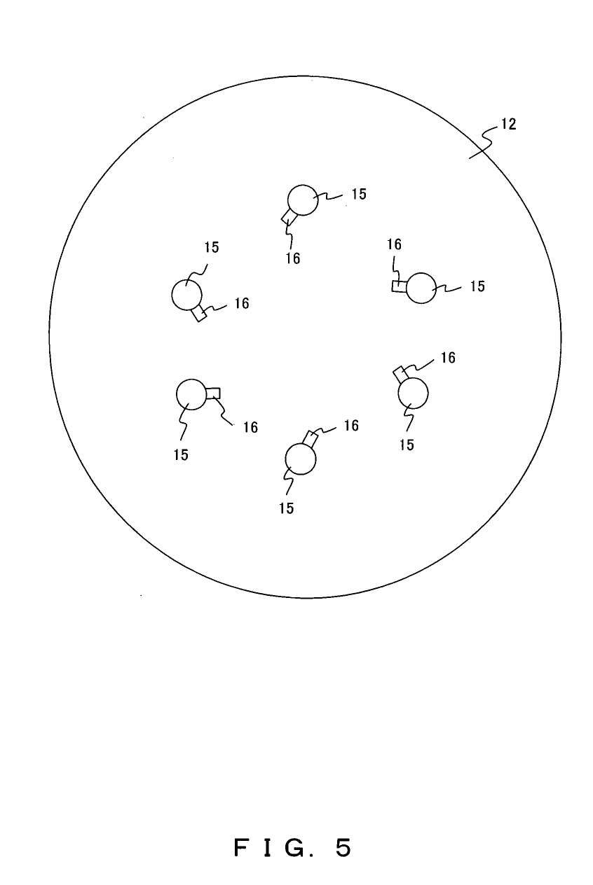

FIGS. 2, 3, 4A and 4B explain the cases where the four pipes 15 are arranged inside the suction tower 12. However, the number of pipes arranged inside the suction tower 12 may be a number (such as six, eight, etc.) other than four. For example, FIG. 5 is a cross-sectional view showing a case where six pipes are arranged in the suction tower 12, when viewed from above.

Additionally, it becomes easier to remove a blind spot of the collecting agent injected from the nozzles in the case where the cross-section of the suction tower 12 is configured to be a circle or almost circle, in comparison with a case where the cross-section is configured to be another shape such as a rectangle. Also as a result of actually conducting an experiment, the effect of removing a hazardous substance in gaseous form (oily smoke, etc.) is higher in a case where the circle or almost circle is adopted as the cross-section of the suction tower 12, in comparison with a case where a shape other than the circle, such as a rectangle, is adopted as the cross-section of the suction tower 12.

One of hazardous substances targeted by the hazardous substance removing apparatus according to the present invention is oily smoke. The oily smoke occurs in the above described processes. For the oily smoke, a water solution of ethylene glycol is used as the collecting agent. The concentration of this water solution also depends on that of oily smoke. However, for example, if the solution is of 5 percent or almost 5 percent, the removing effect can sufficiently exert on most types of oily smoke assumed to occur.

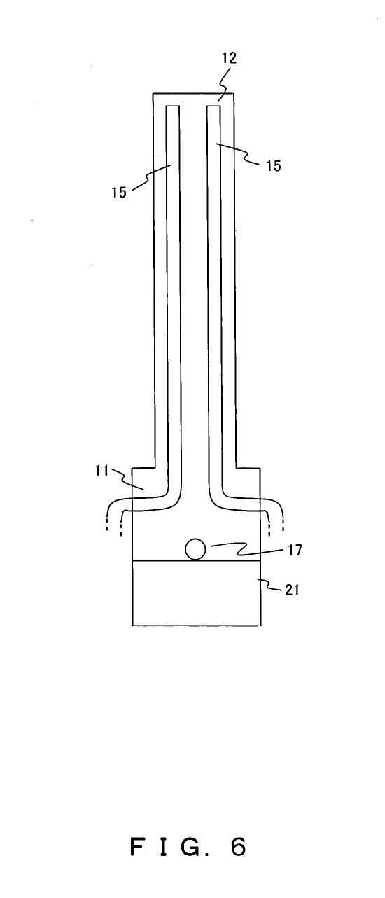

FIG. 6 is a schematic showing the suction tower when viewed in the direction of an arrow X shown in FIG. 1A.

As shown in this figure, a side hole 17 is arranged in a position of a predetermined height in the bath 11. For example, if the collecting agent overflows, it flows out of the side hole 17 by an amount equivalent to the overflow.

Operations of the hazardous substance removing apparatus 10 are described next.

When the hazardous substance removing apparatus 10 is operated, the collecting agent injected from the nozzles 16 blends with a hazardous substance in gaseous form, which flows from the top opening of the suction tower 12, within the suction tower 12. As a result, oil into which the hazardous substance in gaseous form (oily smoke) is liquefied is mixed with a solution of ethylene glycol of 5 percent within the bath 11. Additionally, since the solution of ethylene glycol of 5 percent is continually pumped up by the pump 14, the solution of ethylene glycol of 5 percent and the oil into which the oily smoke is liquefied are in a state of being mixed within the bath 11. Accordingly, to be accurate, the oil to which the oily smoke is liquefied mixes with the collecting agent injected from the nozzles 16.

Upon termination of the operations of the hazardous substance removing apparatus 10, a layer of the oil into which the oily smoke is liquefied is formed on the solution of ethylene glycol of 5 percent. By pouring water into the bath 11, the oil formed in the upper layer is emitted via the side hole 17 by an amount equivalent to the poured water.

Since the hazardous substance removing apparatus 10 itself does not comprise a mechanism for producing a suction pressure (negative pressure) or a positive pressure, the apparatus is used by adding a positive pressure producing unit to a preceding stage, or by adding a suction pressure producing unit to a succeeding stage.

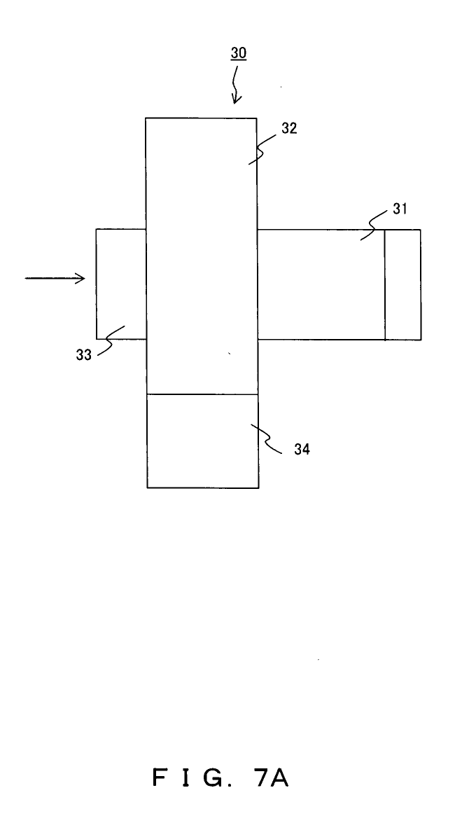

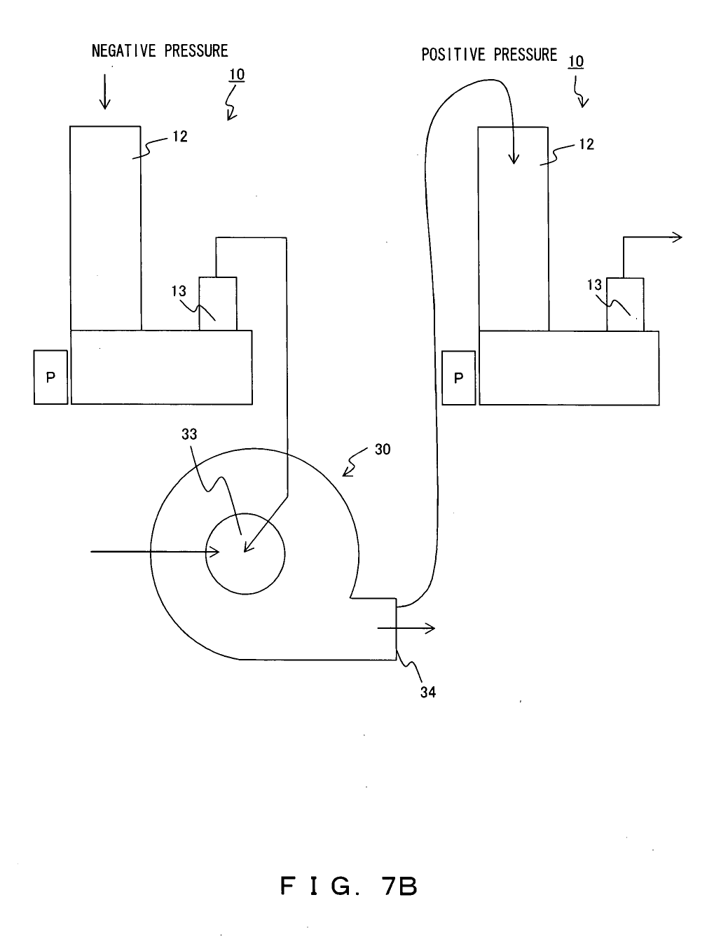

FIG. 7A is a schematic showing the configuration of a blower.

As shown in this figure, the blower 30 comprises a motor 31, a fan (not shown), which is linked to the motor 31 and protected with a housing 32, an inlet opening 33, and an outlet opening 34.

The blower 30 operates in a way such that the fan rotates with the rotation of the motor 31, and gas is suctioned from the inlet opening 33 and emitted from the outlet opening 34.

Accordingly, as shown in FIG. 7B, a suction pressure can be produced within the hazardous substance removing apparatus 10 if the inlet opening 33 of the blower 30 is linked to the top opening of the emission tower 13 of the hazardous substance removing apparatus 10, or a positive pressure can be produced within the hazardous substance removing apparatus 10 if the outlet opening 34 of the blower 30 is linked to the top opening of the suction tower 12 of the hazardous substance removing apparatus 10. As described above, the blower 30 can be used as a positive pressure producing unit or a suction pressure producing unit.

As a matter of course, a positive or suction pressure can be produced with a method other than the blower.

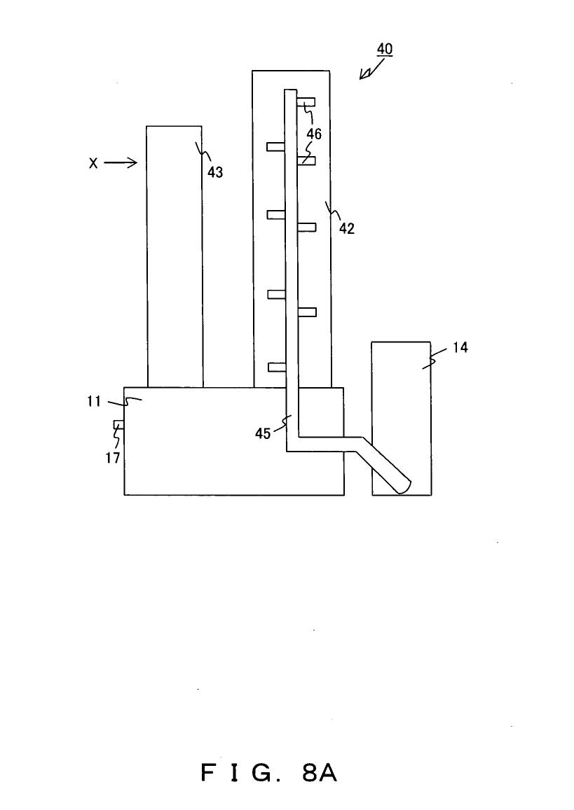

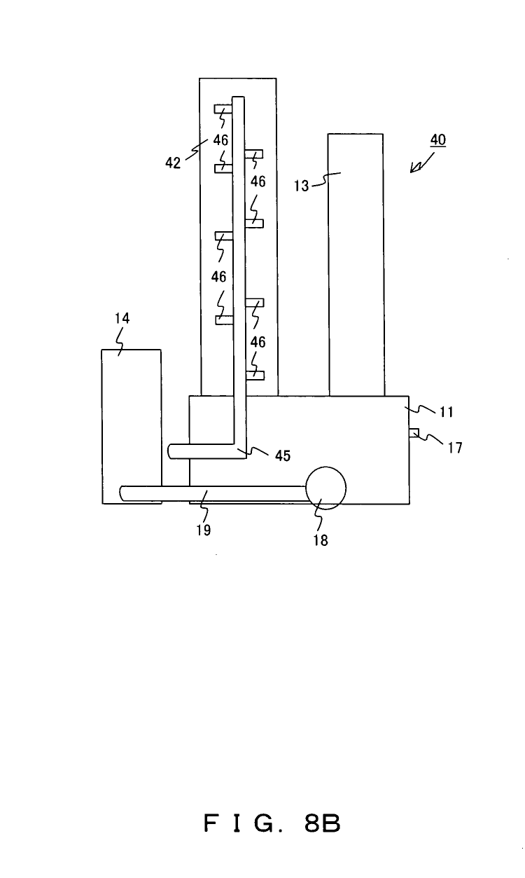

FIGS. 8A and 8B are respectively front and rear views of a hazardous substance removing apparatus according to a second preferred embodiment of the present invention.

In FIG. 8A, the hazardous substance removing apparatus 40 comprises: a bath 11 in which a liquid collecting agent collecting a hazardous substance in gaseous form is stored; a suction tower 42 of a cylindrical or almost cylindrical shape, which blends the hazardous substance in gaseous form suctioned from a top opening of the tower itself with the collecting agent injected from a plurality of nozzles 46 protruding from the inner wall of the tower itself, and sends the blend to the bath 11 via a bottom opening of the tower itself; an emission tower 43 which is open into the bath 11 via a bottom opening of the tower itself, and makes emission via a top opening of the tower itself; and a pump 14 which pumps up the collecting agent within the bath 11. It can be said that the suction tower 42 is a tower unit (cylindrical unit) for promoting the contact between the hazardous substance and the collecting agent.

FIG. 8A is the front view of the apparatus, whereas FIG. 8B is its rear view. As shown in FIG. 8B, the collecting agent within the bath 11 is sent to the pump 14 via a hole 18 and a pipe 19, which exist almost at the bottom of the bath 11, and pumped up to the position of each of the nozzles 46 by the pump 14.

Namely, the collecting agent pumped up by the pump 14 is injected within the suction tower 42 via pipes 45, thinner pipes 46 branching from the pipes 45, and nozzles respectively attached to the tips of the branching pipes 46. As a result, the hazardous substance in gaseous form and the collecting agent are made to contact and blended in the suction tower 42. Each of the nozzles has a thin hole, from which the collecting agent is injected.

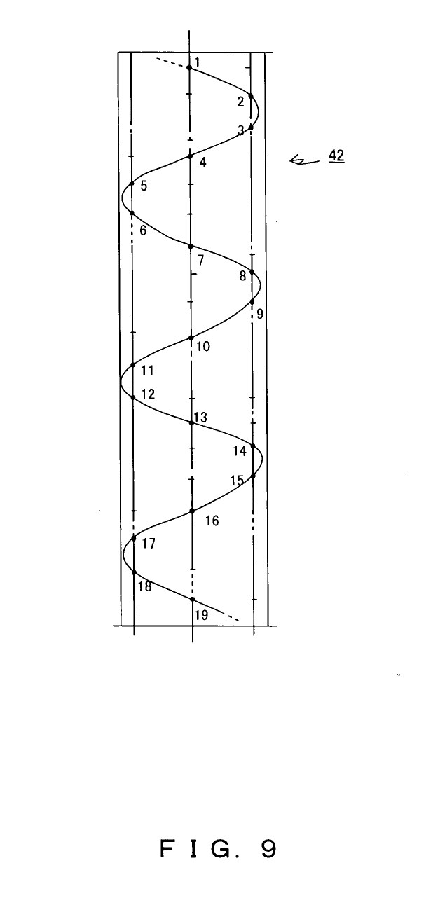

FIG. 9 is a schematic explaining the arrangement of nozzles in the suction tower.

On the inner wall of the suction tower 42, the next nozzle is arranged in a position which goes down by a predetermined amount in the vertical direction of the suction tower 42 and rotates by a predetermined angle (60 degrees in this figure) from the current nozzle position.

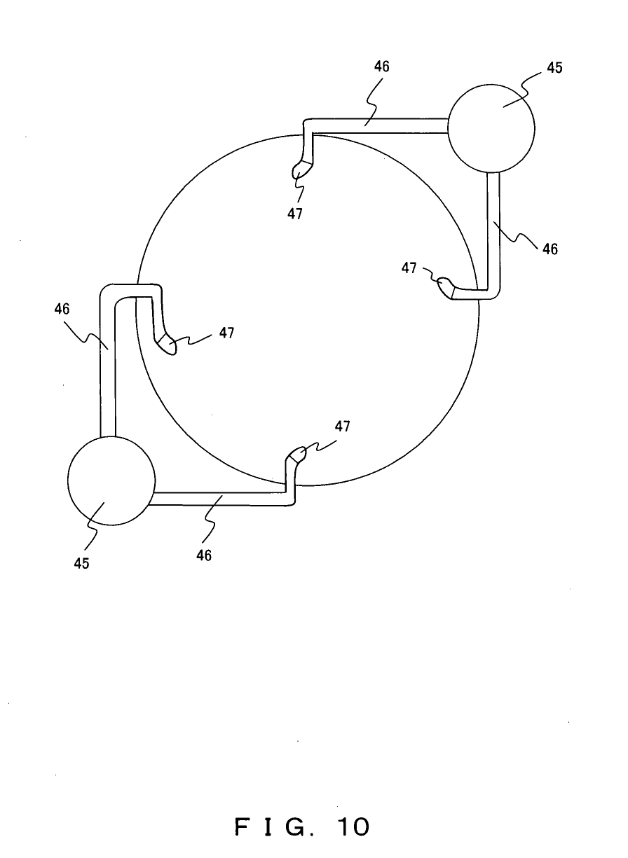

FIG. 10 is a schematic showing the suction tower when viewed from above. In this figure, the next nozzle is arranged in a position which goes down by the predetermined amount in the vertical direction of the suction tower 42 and rotates by 90 degrees from the current nozzle position.

As shown in FIG. 10, each nozzle 47 is attached to the tip of each of pipes 46, which vertically protrudes from the inner wall of the suction tower 42, in a predetermined orientation (right or left) at an angle inclined by a predetermined amount (such as 45 degrees). As a result, the collecting agent injected from each of the nozzles 47 can form a flow along the inner wall.

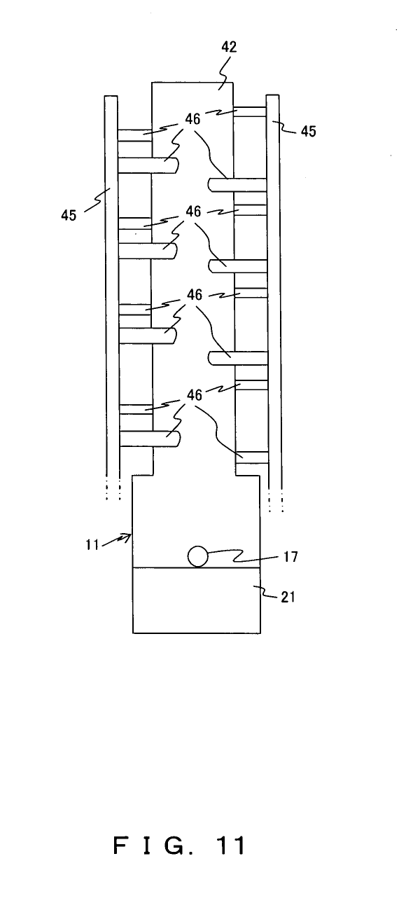

FIG. 11 is a schematic showing the suction tower when viewed in the direction of an arrow X shown in FIG. 8A.

As shown in this figure, a side hole 17 is arranged in a position of a predetermined height in the bath 11. For example, if the collecting agent overflows, it flows out of the side hole 17 by an amount equivalent to the overflow.

Also in the second preferred embodiment, the present applicant found it from an experiment that a case where the respective nozzles are arranged to make the collecting agent injected from the nozzles form a clockwise or counterclockwise flow along the inner wall of the suction tower is one of cases where a hazardous substance in gaseous form is removed to its maximum extent, and the effect of removing a hazardous substance in gaseous form is further increased by making the collecting agent injected from the nozzles remove a blind spot to a maximum extent, in a similar manner as in the first preferred embodiment.

In the second preferred embodiment, the pipes 45 are arranged outside the suction tower, and the pipes 46 branching from the pipes 45 are inserted into holes drilled on the suction tower, and reach the inside of the suction tower in the positions where the nozzles are respectively arranged. Therefore, the work for drilling holes on the suction tower is troublesome. Namely, the pipes 15 are arranged inside the suction tower as in the first preferred embodiment, which makes it easier to manufacture the hazardous substance removing apparatus.

In the above description, the plurality of nozzles are arranged in the positions of the same height in the suction tower in the configuration where the pipes 15 are arranged inside the suction tower, whereas the plurality of nozzles are arranged in the virtual spiral form in the configuration where the pipes 45 are arranged outside the suction tower. However, the arrangement of the nozzles can be determined regardless of whether the pipes are arranged either inside or outside the suction tower. For example, the nozzles may be arranged in a virtual spiral also in the configuration where the pipes 15 are arranged inside the suction tower. Or, the plurality of nozzles may be arranged in position of the same height in the suction tower also in the configuration where the pipes 45 are arranged outside the suction tower.

Each of the preferred embodiments is described by taking oily smoke as an example of a hazardous substance in gaseous form. However, the hazardous substance removing apparatus according to each of the preferred embodiments can be used also for other hazardous substances (in gaseous form) . Examples of the hazardous substances include the following.

### 1. Ammonia or Trimethylamine

A solution of dilute sulfuric acid is used as a collecting agent. The percentage of the solution depends on the concentration of ammonia or trimethylamine to be removed. Normally, a solution of less than 1 percent is used.

### 2. Methyl Mercaptan

A solution of sodium hydroxide is used as a collecting agent. The percentage of the solution depends on the concentration of methyl mercaptan. For example, methyl mercaptan on the order of 1 ppm can be sufficiently removed with a solution on the order of 0.1 percent.

3. volatile Organic Solvent (VOC) (Methyl Acetate, Methyl Isobutyl Ketone, Toluene, Styrene, Xylene, etc.)

Fatty acid methyl ester is used as a collecting agent. For a volatile organic solvent, the ratio of a hazardous substance in gaseous form to be removed with a process once executed by one hazardous substance removing apparatus is low in comparison with oily smoke, etc. Accordingly, it is desirable to link and use a plurality of hazardous substance removing apparatuses.

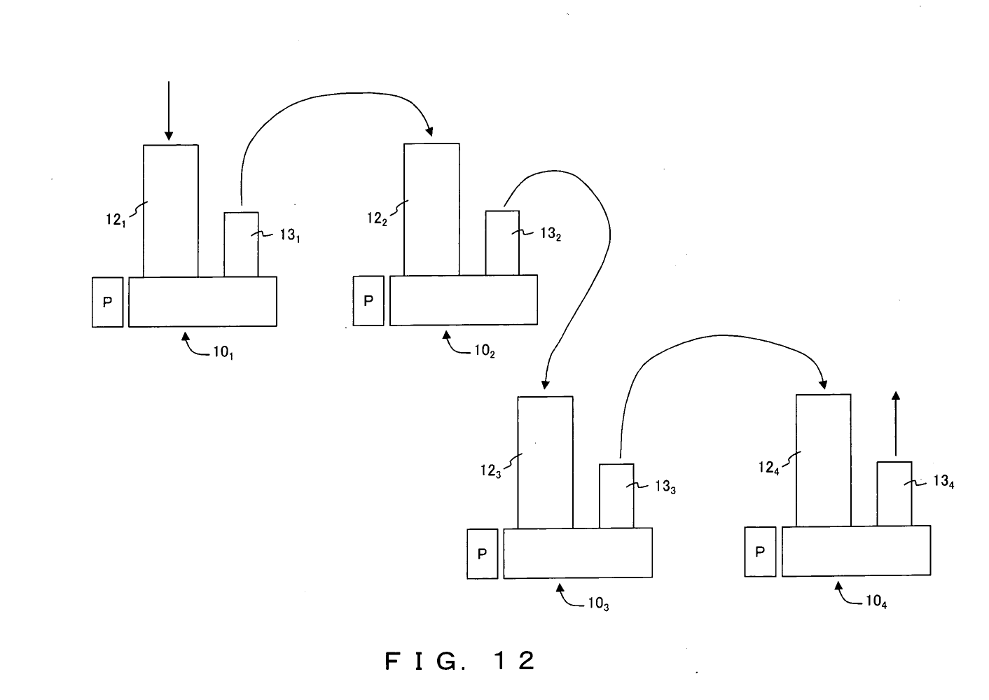

For example, in FIG. 12, a plurality of hazardous substance removing apparatuses are used in a way such that an emission tower 13₁ of the first hazardous substance removing apparatus 10₁ is linked to a suction tower 12₂ of the second hazardous substance removing apparatus 10₂, an emission tower 13₂ of the second hazardous substance removing apparatus 10₂ is linked to a suction tower 12₃ of the third hazardous substance removing apparatus 10₃, and an emission tower 13₃ of the third hazardous substance removing apparatus 10₃ is linked to a suction tower 12₄ of the fourth hazardous substance removing apparatus 10₄.

In the configuration shown in FIG. 12, a positive pressure is produced in a stage preceding the suction tower 12₁ of the first hazardous substance removing apparatus 10₁, or a suction pressure is produced in a stage succeeding the emission tower 13₄ of the fourth hazardous substance removing apparatus 10₄, whereby a volatile organic solvent can be removed by generating a flow of gas from the suction tower 12₁ of the first hazardous substance removing apparatus 10₁ towards the emission tower 13₄ of the fourth hazardous substance removing apparatus 10₄.

What is claimed is:

1. A hazardous substance removing apparatus, comprising:
a bath in which a liquid collecting agent collecting a hazardous substance in gaseous form is stored;
a suction tower of a cylindrical or almost cylindrical shape, which suctions the hazardous substance in gaseous form from a top opening of the tower itself, blends the hazardous substance with the collecting agent injected from a plurality of nozzles arranged inside the tower itself, and sends the blend to said bath via a bottom opening of the tower itself;
an emission tower which is open into said bath via a bottom opening of the tower itself, and can make emission via a top opening of the tower itself; and
a pump which pumps up the collecting agent within said bath, wherein
the plurality of nozzles are arranged inside said suction tower to make the collecting agent injected from the nozzles form a flow along an inner wall.

2. The hazardous substance removing apparatus according to claim 1, wherein
the plurality of nozzles are arranged to make the collecting agent injected from the nozzles form the flow along the inner wall, and the collecting agent is injected from the nozzles to remove or almost remove a blind spot.

3. The hazardous substance removing apparatus according to claim 1, wherein
the plurality of nozzles are attached to sides of a plurality of pipes arranged in a longitudinal direction of said suction tower, and the pipes are arranged inside said suction tower.

4. The hazardous substance removing apparatus according to claim 1, wherein
the plurality of nozzles are attached to tips of pipes branching from the plurality of pipes arranged in the longitudinal direction of said suction tower, and the branching pipes are inserted into said suction tower via holes arranged on a side of said suction tower.

5. The hazardous substance removing apparatus according to claim 1, wherein
the hazardous substance in gaseous form is oily smoke, and the collecting agent is a water solution of ethylene glycol.

6. The hazardous substance removing apparatus according to claim 1, wherein
the hazardous substance in gaseous form is ammonia or trimethylamine, and the collecting agent is a water solution of dilute sulfuric acid.

7. The hazardous substance removing apparatus according to claim 1, wherein
the hazardous substance in gaseous form is methyl mercaptan, and the collecting agent is a water solution of sodium hydroxide.

8. The hazardous substance removing apparatus according to claim 1, wherein
the hazardous substance in gaseous form is a volatile organic solvent, and the collecting agent is fatty acid methyl ester.

9. The hazardous substance removing apparatus according to claim 1, further comprising
a positive pressure producing unit for suctioning the hazardous substance in gaseous form, and for emitting the substance to the top opening of said suction tower.

10. The hazardous substance removing apparatus according to claim 1, further comprising
a suction pressure producing unit for producing a suction pressure to make emission via the top opening of said emission tower, in a stage succeeding the top opening of said emission tower.

11. A cylindrical unit of a cylindrical or almost cylindrical shape, which is intended to promote contact with a hazardous substance and comprises opening at both ends, and inside of which is hollow, wherein:
a hazardous substance in gaseous form is suctioned from the opening at one end, blended with a collecting agent injected from a plurality of nozzles arranged inside the unit itself, and emitted via the opening at the other end; and
the plurality of nozzles are arranged inside the cylindrical unit to make the collecting agent injected from the nozzles form a flow along an inner wall.

12. The cylindrical unit according to claim 11, wherein
the plurality of nozzles are arranged to make the collecting agent injected from the nozzles form the flow along the inner wall, and the collecting agent is injected from the nozzles to remove or almost remove a blind spot.

13. The cylindrical unit according to claim 11, wherein
the plurality of nozzles are attached to sides of a plurality of pipes arranged in a longitudinal direction of the suction tower, and the pipes are arranged inside the suction tower.

14. The cylindrical unit according to claim 11, wherein
the plurality of nozzles are attached to tips of pipes branching from the plurality of pipes arranged in the longitudinal direction of the suction tower, and the branching pipes are inserted into the suction tower via holes arranged on a side of the suction tower.

15. The cylindrical unit according to claim 11, wherein
the hazardous substance in gaseous form is oily smoke, and the collecting agent is a water solution of ethylene glycol.

16. The cylindrical unit according to claim 11, wherein
the hazardous substance in gaseous form is ammonia or trimethylamine, and the collecting agent is a water solution of dilute sulfuric acid.

17. The cylindrical unit according to claim 11, wherein
the hazardous substance in gaseous form is methyl mercaptan, and the collecting agent is a water solution of sodium hydroxide.

18. The cylindrical unit according to claim 11, wherein
the hazardous substance in gaseous form is a volatile organic solvent, and the collecting agent is fatty acid methyl ester.

19. The cylindrical unit according to claim 11, further comprising
a positive pressure producing unit for suctioning the hazardous substance in gaseous form, and for emitting the substance to the opening at the one end.

20. The cylindrical unit according to claim 11, further comprising
a suction pressure producing unit for producing a suction pressure to make emission via the opening at the other end in a stage succeeding the opening at the other end.
